(19) United States
(12) Patent Application Publication
(10) Pub. No.: US 2019/0073358 A1
(43) Pub. Date: Mar. 7, 2019

(54) VOICE TRANSLATION METHOD, VOICE TRANSLATION DEVICE AND SERVER

(71) Applicant: BEIJING BAIDU NETCOM SCIENCE AND TECHNOLOGY CO., LTD., Beijing (CN)

(72) Inventors: Niandong DU, Beijing (CN); Sai MA, Beijing (CN); Yan XIE, Beijing (CN)

(21) Appl. No.: 16/044,659

(22) Filed: Jul. 25, 2018

(30) Foreign Application Priority Data
Sep. 1, 2017 (CN) 201710780647.4

(51) Int. Cl. G06F 17/28; G10L 15/22; G10L 15/04; G10L 15/183

(52) U.S. Cl. CPC G06F 17/289; G10L 15/183; G10L 15/04; G10L 15/22

(57) ABSTRACT

The present disclosure provides a voice translation method, a voice translation device and a server. The voice translation device includes determining a language type of voice data acquired from a terminal; recognizing the voice data based on the language type to acquire first recognition information corresponding to the voice data, the first recognition information including voice data to be translation; determining a target language type and performing a translation process on the first recognition information based on the target language type to acquire a translation result corresponding to the voice data.

### CROSS REFERENCE TO RELATED APPLICATION

This application claims a priority to Chinese Patent Application Serial No. 201710780647.4, filed with the State Intellectual Property Office of P. R. China on Sep. 1, 2017, by BEIJING BAIDU NETCOM SCIENCE AND TECHNOLOGY CO., LTD. and titled with “Voice Translation Method And Voice Translation Device And Server”.

### TECHNICAL FIELD

The present disclosure relates to the field of computer technology, and more particular to a voice translation method, a voice translation device and a server.

### BACKGROUND

At present, with an existing voice translation method, after a voice input by a user is acquired by a terminal, the terminal sends the voice data to a voice recognition server for voice recognition. Corresponding text returned by the voice recognition server is presented to the user. When it is determined that the user triggers a translation operation, a translation request is sent to a translation server to obtain a translation result returned by the translation server, and the translation result is presented to the user.

### SUMMARY

Embodiments of the present disclosure provide a voice translation method. The voice translation method includes: determining a language type of voice data acquired from a terminal; recognizing the voice data based on the language type to acquire first recognition information corresponding to the voice data, the first recognition information including voice data to be translated; determining a target language type and performing a translation process on the first recognition information according to the target language type to acquire a translation result corresponding to the voice data.

Embodiments of the present disclosure provide a server. The server includes a memory, a processor and computer programs stored in the memory and executable by the processor, in which when the computer programs are executed by the processor, the voice translation device described above is realized.

Embodiments of the present disclosure provide a non-transitory computer readable storage medium, having computer programs stored thereon, in which when the computer programs are executed by a processor, the voice translation device described above is realized.

### BRIEF DESCRIPTION OF THE DRAWINGS

The above and additional aspects and advantages of embodiments of the present disclosure will become apparent and more readily appreciated from the following descriptions made with reference to the drawings, in which:

FIG. 1 is a flow chart illustrating a voice translation method according to an embodiment of the present disclosure;

FIG. 2 is a flow chart illustrating a voice translation method according to another embodiment of the present disclosure;

FIG. 3 is a flow chart illustrating a voice translation method according to still another embodiment of the present disclosure;

FIG. 4 is a block diagram illustrating a voice translation device according to an embodiment of the present disclosure; and

FIG. 5 is a block diagram illustrating a voice translation device according to another embodiment of the present disclosure.

FIG. 6 is a schematic diagram illustrating a server according to an embodiment of the present disclosure.

### DETAILED DESCRIPTION

Descriptions will be made in detail to embodiments of the present disclosure. Examples of embodiments described are illustrated in drawings. The same or similar elements and the elements having same or similar functions are denoted by like reference numerals throughout the descriptions. The embodiments described herein with reference to drawings are explanatory, and used to explain the present disclosure and are not construed to limit the present disclosure.

At present, with an existing voice translation method, after a voice input by a user is acquired by a terminal, the terminal sends the voice data to a voice recognition server for voice recognition. Corresponding text returned by the voice recognition server is presented to the user. When it is determined that the user triggers a translation operation, a translation request is sent to a translation server to obtain a translation result returned by the translation server, and the translation result is presented to the user. The above translation method requires multiple data exchanges between the terminal and the server, which not only occupies network resources, but also has a long process, low efficiency, and poor user experience.

Embodiments of the present disclosure provide a voice translation method for solving the above problem. After the voice data sent by the terminal is acquired, a language type of the voice data is determined. The voice data is recognized based on the language type to obtain recognition information corresponding to the voice data. A translation process is performed to the recognition information to acquire a translation result corresponding to the voice data. Therefore, translation of the voice data is implemented without multiple interactions between the terminal and the server, thereby reducing occupation of the network resources, improving translation efficiency and improving user experience.

The voice translation method, a voice translation device and a server according to embodiments of the present disclosure will be described with reference to drawings.

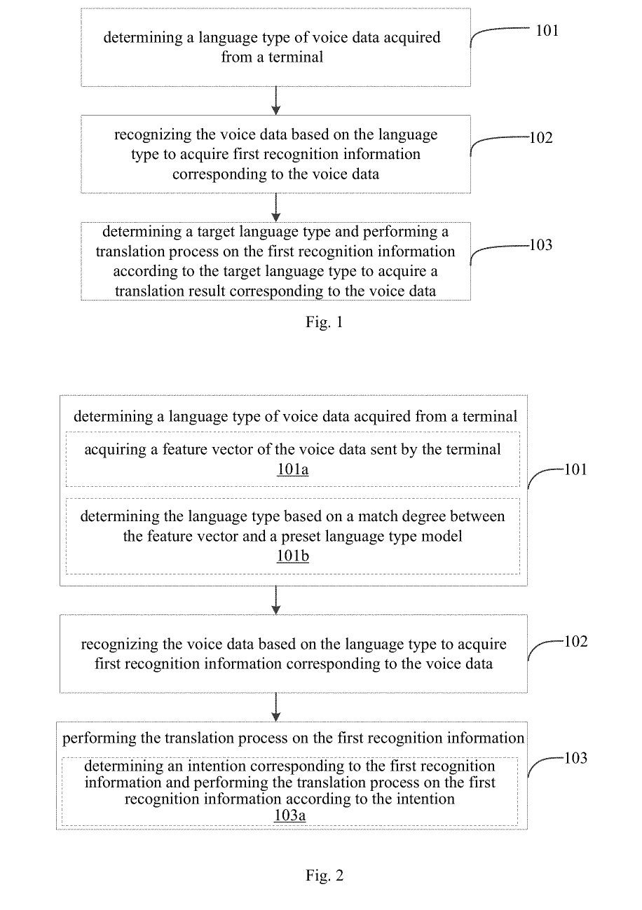

FIG. 1 is a flow chart illustrating a voice translation method according to an embodiment of the present disclosure.

As illustrated in FIG. 1, the voice translation method includes the followings.

In block 101, a language type of voice data acquired from a terminal is determined.

An execution body of the voice translation method provided in embodiments of the present disclosure is the voice translation device according to embodiments of the present disclosure. The voice translation device may be arranged in any server and may be configured to translate the voice data sent by the terminal.

Specifically, a voice input device, such as a microphone, may be arranged in advance in the terminal, such that the terminal is configured to acquire the voice data input by the user with the voice input device and sent the voice data to the voice translation device, when the user desires to perform a translation.

In particular implementations, the block 101 may be realized as following blocks 101a to 101b, as illustrated in FIG. 2.

In block 101a, a feature vector of the voice data sent by the terminal is acquired.

The feature vector is configured to characterize features of the voice data sent by the terminal.

Specifically, after the voice translation device acquires the voice data sent by the terminal, the feature vector of the voice data sent by the terminal may be determined in various ways, such as using Mel-frequency cepstral coefficient, linear prediction cepstral coefficient, multimedia content description interface and the like.

In block 101b, the language type of the voice data is determined based on a match degree between the feature vector and a preset language type model.

Specifically, various language type models may be obtained by training in advance a large amount of historical corpuses of various types of language. After the feature vector of the voice data acquired is determined, the feature vector is input to the various language type models for being verified and scored. The language type of a language type model with a highest score (i.e., the language type model is best matched to the feature vector) is determined as the language type of the voice data.

In block 102, the voice data is recognized based on the language type determined to acquire first recognition information corresponding to the voice data.

Specifically, by training the language models corresponding to various language types in advance, after the language type of the voice data sent by the terminal is determined, the voice data may be recognized using the language model corresponding to the language type, to acquire the first recognition information corresponding to the voice data.

In block 103, a translation process is performed on the first recognition information to acquire a translation result corresponding to the voice data.

Specifically, after the voice data sent by the terminal is acquired, a target language type corresponding to the voice data may be determined, such that the first recognition information is processed with the translation process based on the target language type to obtain the translation result corresponding to the voice data.

It is to be noted that, the translation result refers to a translation result in text, or a translation result in voice, which is not limited herein.

More specifically, translating a certain language type of voice data into different target language types of data may be set in advance to correspond to different translation models. For example, translating the voice data in Chinese into English and Korean respectively corresponds to different translation models. Therefore, after the target language type corresponding to the voice data is determined, the translation process may be performed on the first recognition information based on the translation model corresponding to the target language type.

It is to be noted that, the voice data sent by the terminal may only include the voice data to be translated, or may include the voice data to be translated and the target language type of the voice data to be translated, which is not limited herein. In addition, when the voice data sent by the terminal includes the voice data to be translated and the target language type of the voice data to be translation, performing the translation process on the first recognition information may refer to that only the voice data to be translated is processed with the translation process.

Further, after the voice translation device acquires the translation result corresponding to the voice data, the first recognition information and the translation result may be sent to the terminal, such that the terminal present the first recognition information and the translation result to the user. The user may determine whether recognition of the voice data by the voice translation device is accurate or not according to the first recognition information, to further determine whether the translation result is accurate or not. In other words, after the block 103, the voice translation method may further include sending the first recognition information and the translation result to the terminal.

Specifically, after the terminal acquires the first recognition information and the translation result, the first recognition information and the translation result may be presented to the user in any manners, which is not limited herein. For example, the first recognition information may be displayed to the user by the terminal. After the user confirms the first recognition information, the translation result is displayed subsequently to the user. Alternatively, the first recognition information and the translation result may be displayed simultaneously. Alternatively, the translation result may be played in voice while the first recognition result is displayed on the terminal.

In addition, when intentions of the user are different, translation results corresponding to same recognition information have differences from each other. In order to make the translation result more accurate, in embodiments of the present disclosure, the translation process may be performed on the first recognition information based on the intention of the user. In other words, the block 103 may include a block 103a, as illustrated in FIG. 2.

In block 103a, the intention corresponding to the first recognition information is determined, and the translation process is performed on the first recognition information based on the intention.

Specifically, various intentions may be trained to correspond to various translation models in advance, such that after the first recognition information is acquired and the intention of the first recognition information is recognized, the translation process may be performed on the first recognition information according to the translation model corresponding to the intention recognized.

For example, the intention related to travelling is set in advance to correspond to a translation model A, while the intention related to movies and televisions is set in advance to correspond to a translation model B. When the first recognition information is determined as “How To Go To The Imperial Palace” based on the acquired voice data, by recognizing the intention of the first recognition information, the intention may be determined as requiring a routine to the travelling spot of “Imperial Palace” (i.e., the intention related to travelling). Since the translation model A corresponds to the intention related to travelling, the translation process is performed on the first recognition information based on the translation model A.

It can be understood that, with the voice translation method provided in embodiments of the present disclosure, after the terminal acquires the voice data and sends the voice data to the voice translation device, the voice translation device may be configured to directly perform the translation process on the recognition information after recognizing the voice data. After the translation result is acquired, the voice translation device is configured to send the translation result and the recognition information to the terminal. Therefore, the translation of the acquired voice data may be realized without multiple interactions between the server where the voice translation device is and the terminal.

It is to be noted that, in embodiments of the present disclosure, after the voice translation device acquires the first recognition information corresponding to the voice data, the first recognition information may be sent to the terminal while the translation process is performed on the first recognition information. After the translation result is acquired, the translation result is sent to the terminal.

With the voice translation method according to embodiments of the present disclosure, the language type of the voice data acquired from the terminal is determined, and the voice data is recognized based on the language type to acquire the first recognition information corresponding to the voice data. The translation process is performed on the first recognition information to acquire the translation result corresponding to the voice data. Therefore, the translation of the voice data may be realized without multiple interactions between the terminal and the server, thereby reducing occupation of network resources, improving translation efficiency and improving user experience.

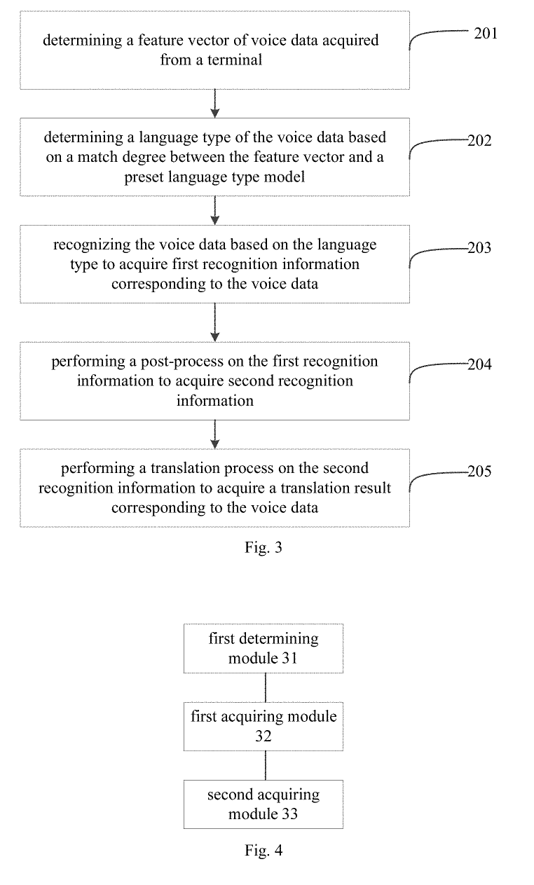

As can be seen from the above descriptions, after the language type of the voice data acquired from the terminal is acquired, the voice data may be recognized based on the language type to acquire the first recognition information corresponding to the voice data. The translation process is performed on the first recognition information to acquire the translation result corresponding to the voice data. In practice, however a result of recognizing the voice data may be not accurate, which will be described in detail with reference to FIG. 3.

FIG. 3 is a flow chart illustrating a voice translation method according to another embodiment of the present disclosure.

As illustrated in FIG. 3, the voice translation method includes the following.

In block 201, a feature vector of voice data acquired from a terminal is determined.

In block 202, a language type of the voice data is determined based on a match degree between the feature vector and a preset language type model.

In block 203, the voice data is recognized based on the language type to acquire first recognition information corresponding to the voice data.

Detailed realization procedures and principles of blocks 201 to 203 may be referred to descriptions made to above embodiments, which are not elaborated herein.

In block 204, a post-process is performed on the first recognition information to generate second recognition information.

In block 205, the translation process is performed on the second recognition information to acquire a translation result corresponding to the voice data.

Specifically, performing the post-process on the first recognition information to generate the second recognition information may be implemented in many manners, such as using word segmentation, part-of-speech tagging, punctuation, correction based on hot words, rewriting or the like.

In particular implementation, after the voice data sent by the terminal is acquired, the target language type corresponding to the voice data may be determined. The translation process is performed on the second recognition information based on the target language type to acquire the translation result corresponding to the voice data. The translation result and the recognition information are sent back to the terminal.

It is to be noted that, the translation result refers to a translation result in text, or a translation result in voice, which is not limited herein.

More specifically, translating a certain language type of voice data into different target language types of data may be set in advance to correspond to different translation models. For example, translating the Chinese type of voice data into English and Korean respectively corresponds to different translation models. Therefore, after the target language type corresponding to the voice data is determined, the translation process may be performed on the second recognition information based on the translation model corresponding to the target language type.

By performing the translation process on the second recognition information that is obtaining by performing the post-process on the first recognition information, the translation result may be more accurate and reliable.

For example, when the voice data input the user is “I want to watch a movie called Once Upon A Time”, the first recognition information may be determined as “I want to watch a movie called One On A Time” by recognizing the voice data. The first recognition information may be corrected to generate the second recognition information of “I want to watch a movie called Once Upon A Time” via the correction based on hot words for example. Therefore, the translation process may be performed on the second recognition information of “I want to watch a movie called Once Upon A Time”. As can be seen from above, the translation result may satisfy requirements of the user better, and is more accurate and reliable.

It is to be noted that, the voice data sent by the terminal may only include the voice data to be translated, or may include the voice data to be translated and the target language type of the voice date to be translated, which is not limited herein. In addition, when the voice data sent by the terminal includes the voice data to be translated and the target language type of the voice data to be translated, the translation process may be performed only on the voice data to be translated when the translation process is performed on the second recognition information.

In particular implementations, the target language type corresponding to the voice data acquired may be determined in many ways.

For example, when the voice data input by the user includes the voice data to be translated and the target language type of the voice data to be translated, after the second recognition information is acquired, the translation process may be directly performed on the second recognition information to acquire the translation result corresponding to the voice data based on the target language type of the voice data to be translated included in the voice data acquired.

For example, the voice “English Translation of How To Go To The White House” is input by the user when the user requires translation. “How To Go To The White House” is the voice data to be translated, and “English” is the target language type of the voice data to be translated. Therefore, after acquiring the recognition information of “How To Go To The White House” by the voice translation device, the “How To Go To White House” may be translated into English according to the target language type of “English”.

Alternatively, when the voice data input by the user only includes the voice data to be translated, the target language type corresponding to the voice data to be translated may be determined by triggering a key having a function of selecting the target language type via a click operation, a long press operation, a slide operation and the like. After the second recognition information is acquired by the voice translation device, the translation process may be performed on the second recognition information based on the target language type determined by the user, to acquire the translation result corresponding to the voice data acquired.

Alternatively, a location of the terminal may be fixed in various manners, such as GPS, WIFI positioning, base station positioning or the like, to determine present positional information of the terminal. A commonly-used language type at the location of the terminal may be determined as the target language type. Therefore, the translation process is performed on the second recognition information according to the target language type to acquire the translation result corresponding to the voice data.

For example, it is determined that the terminal is in Korea by the above positioning process. Since the commonly-used language type of Koreans is Korean, Korean may be determined as the target language type to translate the second recognition information into Korean.

Alternatively, the language type into which the voice data is frequently translated by the user of the terminal is determined based on historical usage information of the terminal, to determine a language type having a highest frequency among historical translations as the target language type corresponding to the voice data currently acquired. Alternatively, a language type used in a latest translation is determined as the target language type corresponding to the voice data currently acquired.

The historical usage information may be historical translation records related to the voice translation performed by the terminal, or other historical usage information, which is not limited herein.

Accordingly, before the block 205, the voice translation method may further include the following.

The target language type is determined based on the present positional information of the terminal.

Alternatively, the target language type is determined according to the historical usage information of the terminal.

The target language type may be any one of Chinese, Korean, English, Japanese or the like.

With the voice translation method according to embodiments of the present disclosure, after the feature vector of the voice data acquired from the terminal is determined, the language type of the voice data is determined based on a match degree between the feature vector and the preset language type model. The voice data is recognized based on the language type to acquire the first recognition information corresponding to the voice data. The first recognition information is post-processed to generate the second recognition information. The translation process is performed on the second recognition information to acquire the translation result corresponding to the voice data. Therefore, the translation of the voice data is realized without multiple interactions between the terminal and the server, thereby reducing occupations of the network resources, improving the translation efficiency and improving the user experience.

FIG. 4 is a block diagram illustrating a voice translation device according to an embodiment of the present disclosure.

As illustrated in FIG. 4, the voice translation device includes a first determining module 31, a first acquiring module 32 and a second acquiring module 33.

The first determining module 31 is configured to determine a language type of voice data acquired from a terminal.

The first acquiring module 32 is configured to recognize the voice data based on the language type to acquire first recognition information corresponding to the voice data.

The second acquiring module 33 is configured to perform a translation process on the first recognition information to acquire a translation result corresponding to the voice data.

Specifically, the voice translation device provided in embodiments may be arranged in any server, and configured to execute the voice translation method provided in above embodiments, for translating the voice data sent by the terminal.

In a possible implementation of embodiments of the present disclosure, the first determining module 31 is configured to acquire a feature vector of the voice data acquired from the terminal; and determine the language type of the voice data based on a match degree between the feature vector and a preset language type model.

In another possible implementation of embodiments of the present disclosure, the second acquiring module 33 is configured to determine an intention corresponding to the first recognition information; and perform the translation process on the first recognition information based on the intention.

It is to be noted that, explanations and descriptions made to the voice translation method in above embodiments are applicable to the voice translation device in embodiments, which are not elaborated herein.

With the voice translation device according to embodiments of the present disclosure, the language type of the voice data acquired from, the terminal is determined. The voice data is recognized based on the determined language type to acquire the first recognition information corresponding to the voice data. The translation process is performed on the first recognition information to acquire the translation result corresponding to the voice data. Therefore, the translation of the voice data is realized without the multiple interactions between the terminal and the server, thereby reducing occupation of network resources, improving translation efficiency and improving user experience.

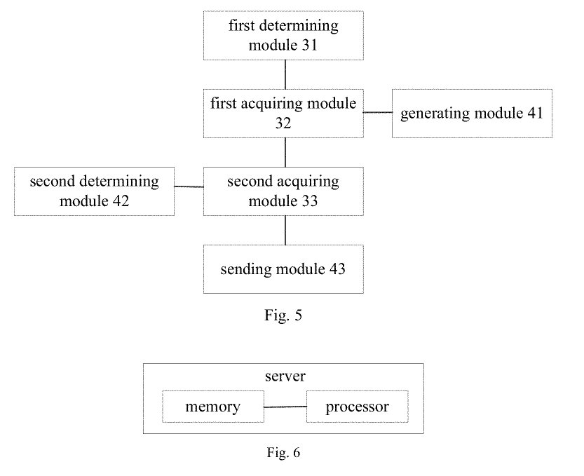

FIG. 5 is a block diagram illustrating a voice translation device according to another embodiment of the present disclosure.

As illustrated in FIG. 5, on the basis of FIG. 4, the voice translation device further includes a generating module 41.

The generating module 41 is configured to perform a post-process on the first recognition information to generate second recognition information.

Accordingly, the second acquiring module 33 is further configured to perform the translation process on the second recognition information.

In a possible implementation of the present disclosure, the voice translation device further includes a second determining module 42. The second determining module 42 is configured to determine a target language type according to present positional information of the terminal, or determine a target language type according to historical usage information of the terminal.

In another possible implementation of the present disclosure, the voice translation device further includes a sending module 43.

The sending module 43 is configured to send the first recognition information and the translation result to the terminal.

It is to be noted that, the explanations and descriptions made to the voice translation device in above embodiments are applicable to the voice translation device in embodiments, which are not elaborated herein.

With the voice translation device according to embodiments of the present disclosure, the language type of the voice data acquired from the terminal is determined, and the voice data is recognized based on the determined language type to acquire the first recognition information corresponding to the voice data. The translation process is performed on the first recognition information to acquire the translation result corresponding to the voice data. Therefore, the translation of the voice data is realized without multiple interactions between the terminal and the server, thereby reducing occupation of network resources, improving translation efficiency and improving user experience.

Embodiments of a third aspect of the present disclosure provide a server. As illustrated in FIG. 6, the server includes a memory, a processor, and computer programs stored in the memory and executable on the processor. When the computer programs are executed by the processor, the voice translation method in above embodiments is realized.

Embodiments of a fourth aspect of the present disclosure provide a computer readable storage medium having computer programs stored thereon. When the computer programs are executed by a processor, the voice translation method in above embodiments is realized.

Embodiments of a fifth aspect of the present disclosure provide a computer program product. When instructions stored in the computer program product are executed by a processor, the voice translation method in above embodiments is realized.

In the description of the present disclosure, reference throughout this specification to “an embodiment,” “some embodiments,” “example,” “a specific example,” or “some examples,” means that a particular feature, structure, material, or characteristic described in connection with the embodiment or example is included in at least one embodiment or example of the present disclosure. In the specification, the terms mentioned above are not necessarily referring to the same embodiment or example of the present disclosure. Furthermore, the particular features, structures, materials, or characteristics may be combined in any suitable manner in one or more embodiments or examples. Besides, any different embodiments and examples and any different characteristics of embodiments and examples may be combined by those skilled in the art without contradiction.

In addition, terms such as “first” and “second” are used herein for purposes of description and are not intended to indicate or imply relative importance or significance. Furthermore, the feature defined with “first” and “second” may comprise one or more this feature distinctly or implicitly. In the description of the present disclosure, “a plurality of” refers to at least two, such as two, three etc., unless specified otherwise.

Any procedure or method described in the flow charts or described in any other way herein may be understood to comprise one or more modules, portions or parts for storing executable codes that realize particular logic functions or procedures. Moreover, advantageous embodiments of the present disclosure comprises other implementations in which the order of execution is different from that which is depicted or discussed, including executing functions in a substantially simultaneous manner or in an opposite order according to the related functions, which should be understood by those skilled in the art.

The logic and/or steps described in other manners herein or illustrated in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but not an exhaustive list: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks or CD, etc.

Although explanatory embodiments have been illustrated and described, it would be appreciated by those skilled in the art that the above embodiments are exemplary and cannot be construed to limit the present disclosure, and changes, modifications, alternatives and varieties can be made in the embodiments by those skilled in the art without departing from scope of the present disclosure.

What is claimed is:

1. A voice translation method, comprising:
determining a language type of voice data acquired from a terminal;
recognizing the voice data based on the language type to acquire first recognition information corresponding to the voice data, the first recognition information comprising voice data to be translated; and
determining a target language type and performing a translation process on the first recognition information according to the target language type to acquire a translation result corresponding to the voice data.

2. The voice translation method according to claim 1, wherein determining the language type of the voice data acquired from the terminal comprises:
determining a feature vector of the voice data acquired from the terminal; and
determining the language type of the voice data based on a match degree between the feature vector and a preset language type model.

3. The voice translation method according to claim 1, before the performing the translation process on the first recognition information, further comprising:
performing a post-process on the first recognition information to generate second recognition information; and
performing the translation process on the first recognition information comprises:
performing the translation process on the second recognition information.

4. The voice translation method according to claim 3, wherein the post-process comprises at least one of word segmentation, part-of-speech tagging, punctuation, correction based on hot words, and rewriting.

5. The voice translation method according to claim 1, wherein performing the translation process on the first recognition information comprises:
determining an intention corresponding to the first recognition information; and
performing the translation process on the first recognition information according to the intention.

6. The voice translation method according to claim 1, wherein the target language type is determined according to present positional information of the terminal or according to historical usage information of the terminal.

7. The voice translation method according to claim 6, after the acquiring the translation result corresponding to the voice data, further comprising:
sending the first recognition information and the translation result to the terminal.

8. A server, comprising:
a memory, a processor and computer programs stored in the memory and executable by the processor, wherein when the computer programs are executed by the processor, a voice translation device is realized, wherein the voice translation device comprises:
determining a language type of voice data acquired from a terminal;
recognizing the voice data based on the language type to acquire first recognition information corresponding to the voice data, the first recognition information comprising voice data to be translated; and
determining a target language type and performing a translation process on the first recognition information according to the target language type to acquire a translation result corresponding to the voice data.

9. The server according to claim 8, wherein determining the language type of the voice data acquired from the terminal comprises:
determining a feature vector of the voice data acquired from the terminal; and
determining the language type of the voice data based on a match degree between the feature vector and a preset language type model.

10. The server according to claim 8, wherein before the performing the translation process on the first recognition information, the method further comprises:
performing a post-process on the first recognition information to generate second recognition information; and
performing the translation process on the first recognition information comprises:
performing the translation process on the second recognition information.

11. The server according to claim 10, wherein the post-process comprises at least one of word segmentation, part-of-speech tagging, punctuation, correction based on hot words, and rewriting.

12. The server according to claim 8, wherein performing the translation process on the first recognition information comprises:
determining an intention corresponding to the first recognition information; and
performing the translation process on the first recognition information according to the intention.

13. The server according to claim 8, wherein the target language type is determined according to present positional information of the terminal or according to historical usage information of the terminal.

14. The server according to claim 13, wherein after the acquiring the translation result corresponding to the voice data, the method further comprises:
sending the first recognition information and the translation result to the terminal.

15. A non-transitory computer readable storage medium, having computer programs stored thereon, wherein when the computer programs are executed by a processor, a voice translation method is realized, wherein the method comprises:
determining a language type of voice data acquired from a terminal;
recognizing the voice data based on the language type to acquire first recognition information corresponding to the voice data, the first recognition information comprising voice data to be translated; and
determining a target language type and performing a translation process on the first recognition information according to the target language type to acquire a translation result corresponding to the voice data.

16. The non-transitory computer readable storage medium according to claim 15, wherein determining the language type of the voice data acquired from the terminal comprises:
determining a feature vector of the voice data acquired from the terminal; and
determining the language type of the voice data based on a match degree between the feature vector and a preset language type model.

17. The non-transitory computer readable storage medium according to claim 15, wherein before the performing the translation process on the first recognition information, the method further comprises:
performing a post-process on the first recognition information to generate second recognition information; and
performing the translation process on the first recognition information comprises:
performing the translation process on the second recognition information.

18. The non-transitory computer readable storage medium according to claim 17, wherein the post-process comprises at least one of word segmentation, part-of-speech tagging, punctuation, correction based on hot words, and rewriting.

19. The non-transitory computer readable storage medium according to claim 15, wherein performing the translation process on the first recognition information comprises:
determining an intention corresponding to the first recognition information; and
performing the translation process on the first recognition information according to the intention.

20. The non-transitory computer readable storage medium according to claim 15, wherein the target language type is determined according to current positional information of the terminal or according to historical usage information of the terminal.
